(19) United States
(12) Patent Application Publication
(10) Pub. No.: US 2008/0224368 A1
(43) Pub. Date: Sep. 18, 2008

(54) VIBRATION DAMPING BUSH AND VIBRATION DAMPING BUSH ASSEMBLY

(75) Inventor: Kazuhiko KATO, Komaki-Shi (JP)

Correspondence Address: BURR & BROWN, PO BOX 7068, SYRACUSE, NY, 13261-7068, US

(73) Assignee: Tokai Rubber Industries, Ltd., Komaki-Shi (JP)

(21) Appl. No.: 12/027,326

(22) Filed: Feb. 7, 2008

(30) Foreign Application Priority Data
Mar. 14, 2007 (JP) 2007-064380

(51) Int. Cl. F16F 1/38

(52) U.S. Cl. 267/140.12

(57) ABSTRACT

A vibration damping bush including: an inner shaft member, an outer cylindrical resin member, an elastic body, and a metal sleeve. The metal sleeve is externally fitted onto the outer cylindrical resin member that is disposed radially outwardly of the inner shaft member with the elastic body interposed therebetween. The outer cylindrical resin member includes a reduced diameter portion positioned inside of and reduced by a retaining portion of the metal sleeve and an enlarged diameter portion positioned axially adjacent to the reduced diameter portion. A boundary portion between the reduced diameter portion and the enlarged diameter portion of the outer cylindrical resin member is engaged with an engagement corner portion circumferentially positioned on an inner circumferential surface side of an axial edge region of the retaining portion of the metal sleeve, thereby restricting an axial displacement of the outer cylindrical resin member with respect to the metal sleeve.

This application is based on Japanese Patent Application No. 2007-064380 filed on Mar. 14, 2007, the contents of which are incorporated hereinto by reference.

### BACKGROUND OF THE INVENTION

1. Field of the Invention

The present invention relates to a vibration damping bush and a vibration damping bush assembly, and more particularly to an improved structure of a vibration damping bush having an elastic body connecting an inner shaft member and an outer cylindrical resin member disposed radially outwardly of the inner shaft member, as well as to a vibration damping bush assembly including the vibration damping bush and a mounting member.

2. Description of the Related Art

Conventionally, as one type of vibration damping connectors and vibration damping supports interposed between two members of a vibration transfer system, there is known a vibration damping bush (a cylindrical vibration damper) which includes an inner shaft member, an outer cylindrical member disposed radially outwardly of the inner shaft member and an elastic body interposed therebetween for elastic connection. The vibration damping bush is, for example, used for an engine mount, a suspension bush (a suspension mount), a differential mount, a body mount, or the like.

In recent years, use of an outer cylindrical member made of resin has been considered for the purpose of reducing a weight and the like of the vibration damping bush of the above described type. However, there exist inherent problems as below. That is, the vibration damping bush is usually used, for example, by press-fitting and fixing the outer cylindrical resin member into a tubular portion of a mounting member such as a bracket (including an entirely cylindrical bracket) to be mounted on one of two members in a vibration transfer system. Thus, when the outer cylindrical member is made of resin, in the initial stage of using the vibration damping bush, the outer cylindrical resin member pressed into the tubular portion of the mounting member can be maintained in a sufficiently fixed condition by resilience of resin. However, through a long period of use, the resilience of resin is decreased because of environmental temperature changes or the like. This causes a problem of weakening of a so-called detachment-resistant strength, namely, resistant force against detachment of the outer cylindrical resin member from the tubular portion of the mounting member.

Under such a circumstance, U.S. Pat. No. 7,104,533, JP-A-2004-211810 and the like disclose a vibration damping bush in which on an inner circumferential surface of a tubular portion of a mounting member, there is provided a stepped portion having a small inner diameter portion on an axial first side of the tubular portion and having a large inner diameter portion on an axial second side thereof. An outer cylindrical member made of resin is pressed into the tubular portion of the mounting member having the stepped portion, whereby the diameter of a portion of the outer cylindrical resin member positioned inside the small diameter portion of the tubular portion of the mounting member is reduced by the small diameter portion. Additionally, the diameter of a portion of the outer cylindrical resin member positioned inside the large diameter portion of the tubular portion thereof is gradually enlarged by resilience of resin. Then, a boundary portion between the reduced diameter portion and the enlarged diameter portion of the outer cylindrical resin member is engaged with an inner corner portion of the stepped portion of the tubular portion. In the vibration damping bush described above, the boundary portion between the reduced and the enlarged diameter portions of the outer cylindrical resin member is engaged with the inner corner portion of the stepped portion. Accordingly, even if the resilience of resin is decreased more or less because of its long-term use, it can be prevented that the outer cylindrical resin member is detached from the inside of the tubular portion in a direction from the enlarged diameter portion of the outer cylindrical resin member to the reduced diameter portion thereof.

In the vibration damping bush above, however, the stepped portion on the inner circumferential surface of the tubular portion of the mounting member is the only means for preventing the detachment of the outer cylindrical resin member from the inside of the tubular portion thereof. The vibration damping bush itself has no means for preventing the detachment thereof. Therefore, when using the vibration damping bush, an extra process on the tubular portion of the mounting member is required to prevent the detachment of the outer cylindrical resin member from the tubular portion thereof.

### SUMMARY OF THE INVENTION

The preset invention has been made in the light of the situations described above. It is therefore an object of the invention to provide a vibration damping bush having an improved structure which can steadily and stably ensure the prevention of detachment of an outer cylindrical resin member from the inside of a tubular portion of a mounting member over a long period of time, without requiring any extra process on the tubular portion of the mounting member. It is another object of the invention to provide a vibration damping bush assembly including the vibration damping bush having the improved structure and the mounting member.

The above object may be attained according to a first aspect of the present invention, which provides a vibration damping bush including an inner shaft member; an outer cylindrical resin member disposed radially outwardly of the inner shaft member with a predetermined distance therebetween and to be fixed in a tubular portion of a rigid mounting member; an elastic body interposed between and elastically connecting the inner shaft member and the outer cylindrical resin member; and a metal sleeve externally fitted onto the outer cylindrical resin member and to be fixed in the tubular portion of the mounting member, wherein the metal sleeve includes a retaining portion having an inner diameter smaller than an outer diameter of the outer cylindrical resin member, and an engagement corner portion circumferentially positioned on an inner circumferential surface side of an axial edge region of the retaining portion of the metal sleeve; the outer cylindrical resin member includes a reduced diameter portion positioned inside of and reduced by the retaining portion of the metal sleeve and an enlarged diameter portion positioned axially adjacent to the reduced diameter portion with a diameter gradually enlarged toward a side opposite to the reduced diameter portion in a state where the metal sleeve is externally fitted onto the outer cylindrical resin member, whereby the outer cylindrical resin member is retained by the retaining portion of the metal sleeve at the reduced diameter portion thereof; and a boundary portion between the reduced diameter portion and the enlarged diameter portion of the outer cylindrical resin member is engaged with the engagement corner portion of the metal sleeve, thereby restricting an axial displacement of the outer cylindrical resin member from the enlarged diameter portion to the reduced diameter portion with respect to the metal sleeve.

According to a preferable aspect of the vibration damping bush of the present invention, an axial middle portion of the outer cylindrical resin member is formed as the reduced diameter portion, whereas a first axial end portion of the outer cylindrical resin member is formed as the enlarged diameter portion, and the vibration damping bush further comprises an outer flange integrally and circumferentially disposed on a second axial end portion of the outer cylindrical resin member, the outer flange being engaged with an end surface opposite to the engagement corner portion of the retaining portion of the metal sleeve in the state where the metal sleeve is externally fitted onto the outer cylindrical resin member, thereby restricting an axial displacement of the outer cylindrical resin member from the reduced diameter portion to the enlarged diameter portion with respect to the metal sleeve.

According to a preferable aspect of the vibration damping bush of the present invention, an axial middle portion of the outer cylindrical resin member is formed as the reduced diameter portion, whereas each of axially opposite end portions of the outer cylindrical resin member is formed as the enlarged diameter portion, and boundary portions between each of the enlarged diameter portions and the reduced diameter portion positioned between the enlarged diameter portions is engaged with each of the engagement corner portions circumferentially positioned on the inner circumferential surface side of each of the axial edge regions on axially opposite sides of the retaining portion of the metal sleeve, thereby restricting a displacement of the outer cylindrical resin member toward the axially opposite sides with respect to the metal sleeve.

The above-indicated another object of the present invention relating to the vibration damping bush assembly may be attained according to a second aspect of the invention, which provides a vibration damping bush assembly including a vibration damping bush and a rigid mounting member, the vibration damping bush comprising an inner shaft member; an outer cylindrical resin member disposed radially outwardly of the inner shaft member with a predetermined distance therebetween and to be fixed in a tubular portion of a rigid mounting member; and an elastic body interposed between and elastically connecting the inner shaft member and the outer cylindrical resin member, wherein the vibration damping bush further comprise a metal sleeve externally fitted onto the outer cylindrical resin member, the metal sleeve including a retaining portion having an inner diameter smaller than an outer diameter of the outer cylindrical resin member, and an engagement corner portion circumferentially positioned on an inner circumferential surface side of an axial edge region of the retaining portion in the metal sleeve; wherein the outer cylindrical resin member includes a reduced diameter portion positioned inside of and reduced by the retaining portion of the metal sleeve and an enlarged diameter portion positioned axially adjacent to the reduced diameter portion with a diameter gradually enlarged toward a side opposite to the reduced diameter portion in a state where the metal sleeve is externally fitted onto the outer cylindrical resin member, whereby the outer cylindrical resin member is retained by the retaining portion of the metal sleeve at the reduced diameter portion thereof; and wherein a boundary portion between the reduced diameter portion and the enlarged diameter portion of the outer cylindrical resin member is engaged with the engagement corner portion of the metal sleeve, thereby restricting an axial displacement of the outer cylindrical resin member from the enlarged diameter portion to the reduced diameter portion with respect to the metal sleeve, the metal sleeve of the vibration damping bush being press-fitted into a tubular portion of the mounting member, whereby the outer cylindrical resin member is inserted and fixed into the tubular portion of the mounting member to construct the vibration damping bush assembly.

As described above, in the vibration damping bush according to the first aspect of the invention, the outer cylindrical resin member and the metal sleeve externally fitted thereon is provided with the structure for restricting the displacement of the outer cylindrical resin member toward the axially one end side with respect to the metal sleeve, thereby preventing the detachment of the outer cylindrical resin member from the inside of the metal sleeve. Then, the above metal sleeve is inserted and fixed in the tubular portion thereof, for example, by simply press-fitting, as in the case of an outer cylindrical member made of metal inserted and fixed in the tubular portion of the mounting member.

In this manner, the vibration damping bush of the first aspect of the present invention can sufficiently obtain a resistant strength of the metal sleeve against detachment from the tubular portion of the mounting member equivalent to a resistant strength of the outer cylindrical metal member against detachment from the tubular portion of the mounting member in the conventional product in which the outer cylindrical metal member is directly inserted and fixed in the tubular portion thereof. Additionally, the present invention can sufficiently secure a resistant strength of the outer cylindrical resin member against detachment from the metal sleeve equivalent to a resistant strength of the outer cylindrical resin member against detachment from the tubular portion of the mounting member in the conventional product in which the outer cylindrical resin member is inserted into the tubular portion of the mounting member to engage the outer cylindrical resin member with the stepped portion provided on the inner circumferential surface of the tubular portion thereof.

The vibration damping bush according to the first aspect of the present invention can be more advantageous as compared to the conventional product in which the inner circumferential surface of the outer cylindrical resin member is engaged with the stepped portion provided on the inner circumferential surface of the tubular portion of the mounting member to prevent the detachment of the outer cylindrical resin member from the tubular portion thereof. Specifically, the outer cylindrical resin member of the vibration damping bush of the first aspect is inserted and fixed in the tubular portion of the mounting member via the metal sleeve, for example, simply by press-fitting the metal sleeve into the tubular portion of the mounting member, without requiring any special portion such as a stepped portion on the inner circumferential surface of the tubular portion of the mounting member while advantageously preventing the detachment of the outer cylindrical resin member from the tubular portion thereof.

Accordingly, in the vibration damping bush according to the preferable aspect of the present invention, without any extra process on the tubular portion of the mounting member and consequently without any time, labor, and cost for such a process, it can be steadily and stably prevented over a long period of time that the outer cylindrical resin member is detached from the inside of the tubular portion of the mounting member. As a result, in the vibration damping bush interposed between two members of a vibration transfer system, excellent vibration damping performance can stably be exhibited over a longer period of time. Moreover, the excellent characteristics can be very advantageously obtained while achieving improvement of workability and cost reduction in the process of interposing the vibration damping bush between the two members.

Additionally, in the vibration damping bush according to the preferable aspect of the present invention, the outer flange is provided on the outer cylindrical resin member and engaged with the end surface of the metal sleeve in the state where the metal sleeve is externally fitted onto the outer cylindrical resin member, thereby restricting the axial displacement of the outer cylindrical resin member from the reduced diameter portion to the enlarged diameter portion with respect to the metal sleeve. This can advantageously prevent the detachment of the outer cylindrical resin member from the metal sleeve, and furthermore, from the tubular portion of the mounting member in the axially opposite directions. As a result, the vibration damping bush can stably exhibit the excellent vibration damping performance over a much longer period of time when interposed between the two members in the vibration transfer system.

Furthermore, in the vibration damping bush according to the preferable aspect of the present invention, the axially opposite end portions of the outer cylindrical resin member having the reduced diameter portion therebetween are formed as the enlarged diameter portions, each of which is engaged with the engagement corner portion provided on the portion of the inner circumferential surface on the axially opposite sides of the metal sleeve, thereby restricting the displacement of the outer cylindrical resin member toward the axially opposite sides with respect to the metal sleeve. This also can advantageously prevent the detachment of the outer cylindrical resin member from the inside of the metal sleeve, and furthermore, from the inside of the tubular portion of the mounting member in the axially opposite directions. In this manner, when interposed between the two members of the vibration transfer system, the vibration damping bush can stably exhibit excellent vibration damping performance over a much longer period of time.

In the vibration damping bush assembly according to the second aspect of the invention, the metal sleeve of the vibration damping bush having the foregoing excellent characteristics is press-fitted into the tubular portion of the mounting member, so as to allow the outer cylindrical resin member to be inserted and fixed in the tubular portion thereof via the metal sleeve. Accordingly, the assembly can very advantageously exhibit substantially the same functions and effects as those obtained in the vibration damping bush of the first aspect of the present invention. Additionally, in the entire vibration damping bush assembly, reduction in production cost and improvement in workability of production work can both be advantageously achieved.

### BRIEF DESCRIPTION OF THE DRAWINGS

The above and other objects, features, advantages and technical and industrial significance of the present invention will be better understood by reading the following detailed description of presently preferred embodiments of the invention, when considered in connection with the accompanying drawings, in which:

FIG. 1 is an elavational view in axial cross section showing a vibration damping bush according to one embodiment of the present application;

FIG. 2 is an illustration viewed from the direction of arrow II in FIG. 1;

FIG. 3 is an explanatory view showing an integrally vulcanized molded product and a metal sleeve included in the vibration damping bush shown in FIG. 1 in a state before the former is press-fitted into the latter;

FIG. 4 is a partially enlarged view of IV in FIG. 1;

FIG. 5 is an elevational view in axial cross section showing a vibration damping bush assembly in which a mounting tubular portion of a mounting member is disposed on the vibration damping bush shown in FIG. 1; and

FIG. 6 is an illustration showing another example of the vibration damping bush having the structure according to the present invention and corresponding to FIG. 1.

### DETAILED DESCRIPTION OF THE PREFERRED EMBODIMENTS

To further clarify the present invention, there will be described in detail embodiments of the invention with reference to the drawings.

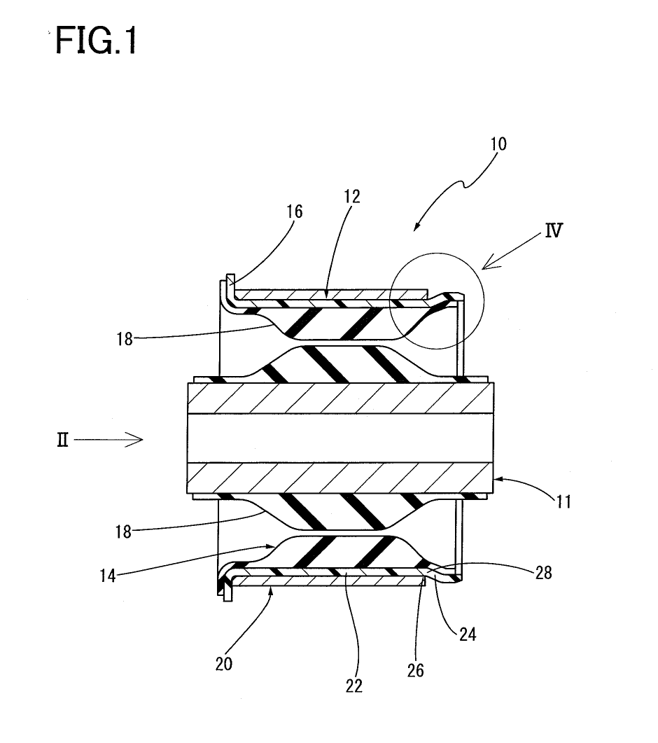

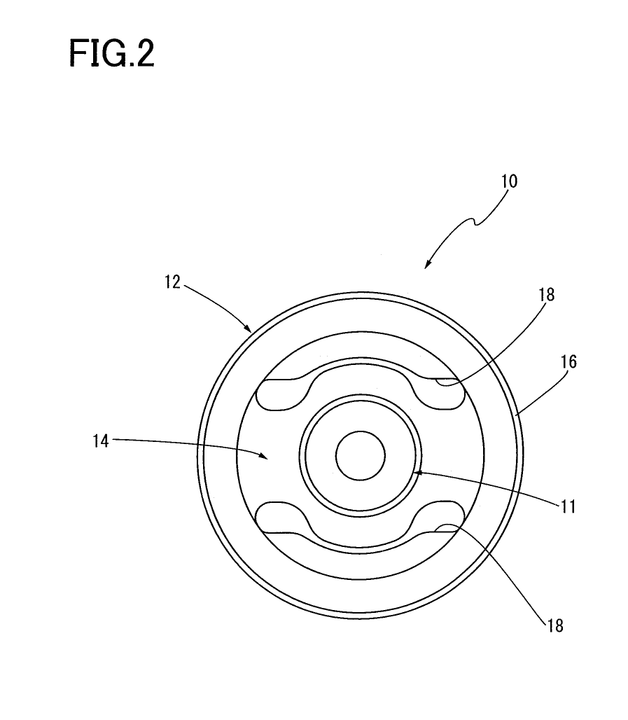

Referring first to FIGS. 1 and 2, there is shown an axial cross sectional view and a side view of a suspension bush to be interposed between a trailing arm and a vehicle body frame in a torsion beam rear suspension of an automobile, as an embodiment of the vibration damping bush according to the present invention. As apparent from the drawings, a suspension bush 10 includes an inner cylindrical member 11 as an inner shaft member and an outer cylindrical member 12 as an outer cylindrical resin member. The inner cylindrical member 11 is disposed coaxially with the outer cylindrical member 12, such that the members 11, 12 are spaced apart from each other with a predetermined radial distance therebetween. The members 11, 12 are integrally connected to each other by an elastic body 14 interposed therebetween. In the suspension bush 10 constructed as above, the inner cylindrical member 11 is mounted on the trailing arm side and the outer cylindrical member 12 is mounted on the vehicle body frame side, thereby allowing the trailing arm to provide a vibration damping support to the vehicle body frame. Under the mounting condition, a major vibration load is input between the inner and the outer cylindrical members 11 and 12 in perpendicular direction to their axes.

More specifically, the inner cylindrical member 11 is made of metal, and as a whole, has a thick cylindrical shape having a predetermined length (height). The outer cylindrical member 12 is made of synthetic resin, and as a whole, has a thin cylindrical shape. Additionally, the outer cylindrical member 12 has an axial length (height) shorter by a predetermined size than the length of the inner cylindrical member 11 and has an inner diameter much larger than an outer diameter of the inner cylindrical member 11.

The kind of the synthetic resin as the material of the outer cylindrical member 12 is not particularly limited. As far as the material exhibits resin elasticity when it is molded in a cylindrical shape, any of thermoplastic and thermosetting resin materials can be used. Among them, it is preferable to use thermoplastic resin having excellent shock-resistant strength against vibration input and excellent moldability. Concrete examples of preferable thermoplastic resin materials include polyamide (including aromatic polyamide and modified polyamide), polyester (including modified polyester), polypropylene, polycarbonate, polyacetal, polyphenyl sulfide, and modified polyphenylene ether. Above all, particularly, polyamide is preferably used due to its excellent balance among strength, reinforcing effect with mixed filler, and cost.

As a material for forming the outer cylindrical member 12, the above exemplified resin materials are each used alone or in a combination with or mixture of various reinforcing fillers in an appropriate ratio. The fillers combined with or mixed in the resin materials may be, for example, glass fiber, carbon fiber, aramid fiber, boron fiber, alumina fiber, metal fiber, silicon carbide fiber, glass bead, whisker, wollastonite, carbon nanotube, and layered phyllosilicate formed of magnesium silicate or aluminum silicate layers, such as kaolinite, talc, mica, montmorillonite, hectorite, vermiculite, or halloysite. Above all, in terms of a good reinforcing effect and cost, glass fiber is particularly preferable.

In the outer cylindrical member 12 made of the resin as described above, an outer flange 16 is integrally and circumferentially or peripherally formed at an axial end (a left side in FIG. 1) thereof. Specifically, the outer flange 16 has a thin annular plate shape, which protrudes in the radially outward direction with a predetermined distance and extends continuously in the circumferential direction of the outer cylindrical member 12, and is formed integrally with an outer circumferential surface of the axial end of the outer cylindrical member 12. Hereinafter, for an illustrative convenience, a side where the outer flange 16 of the outer cylindrical member 12 provided in the suspension bush 10 is referred to as the “left” side and a side opposite thereto is referred to as the “right” side.

The elastic body 14 has a substantially thick cylindrical shape as a whole. The inner cylindrical member 11 is vulcanized and bonded to an inner circumferential surface thereof, and the outer cylindrical member 12 is vulcanized and bonded to an outer circumferential surface thereof, whereby the elastic body 14 is formed as an integrally vulcanized molded product. In addition, in the elastic body 14, at portions on radially opposite sides with the inner cylindrical member 11 interposed therebetween, there are provided hollow portions (spaces) 18, 18 that extend continuously in an axial direction (a horizontal direction) over the entire length thereof. Thereby, the elastic body 14 is substantially split into three parts: an inner rubber portion, which is sandwiched by the two hollow portions 18, 18 and surrounds a circumference of the inner cylindrical member 11, and two outer rubber portions, each of which is separated from the inner rubber portion by each of the two hollow portions 18, 18 to be located on a side opposite to the inner rubber portion. In this manner, spring characteristics of the entire elastic body 14 in a direction perpendicular to an axial direction thereof are relatively softened.

Particularly, in the suspension bush 10 of the embodiment constructed above, a metal sleeve 20 is externally fitted and fixed to the outer cylindrical member 12. The metal sleeve 20, as a whole, has a cylindrical shape, which extends axially with a predetermined thickness substantially equal to or larger than a thickness of the outer cylindrical member 12 and with a constant inner diameter, whereby the metal sleeve 20 has rigidity sufficiently larger than that of the outer cylindrical resin member 12.

In the metal sleeve 20, inner and outer circumferential surfaces thereof are smooth surfaces, and an axial length (height) of the metal sleeve 20 is made smaller by a predetermined size than a length of the outer cylindrical member 12. Furthermore, an inner diameter of the metal sleeve 20 is made smaller by a predetermined size than an outer diameter of the outer cylindrical member 12, whereas an outer diameter thereof is made larger by a predetermined size than an outer diameter of the outer cylindrical member 12. Then, the metal sleeve 20 constructed above is externally disposed on the outer cylindrical member 12 in a state where a left end surface of the metal sleeve 20 is abutted with a right side surface of the outer flange 16, of side surfaces located on opposite sides in a thickness direction of the outer flange 16 of the outer cylindrical member 12, continuing to the outer circumferential surface of the outer cylindrical member 12.

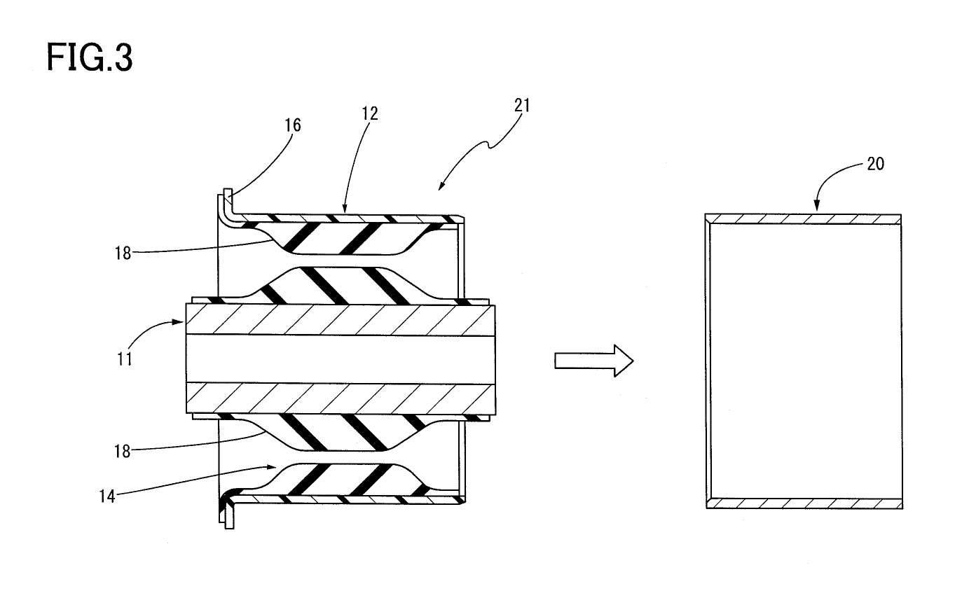

In the suspension bush 10 of the present embodiment, FIG. 3 shows a state before the metal sleeve 20 is externally fitted and fixed onto the outer cylindrical member 12, namely, a state where the elastic body 14 is formed as an integrally vulcanized molded product 21 comprised of the inner cylindrical member 11 and the outer cylindrical member 12 bonded to the inner circumferential surface and the outer circumferential surface of the elastic body 14, respectively, by vulcanization. In this state, the outer cylindrical member 12 has a cylindrical shape having an outer diameter with a constant thickness and a constant diameter larger by a predetermined size than an inner diameter of the metal sleeve 20 and extending in the axial direction. As indicated by an outline arrow in FIG. 3, the above integrally vulcanized molded product 21 including the outer cylindrical member 12 is press-fitted into an inner hole of the metal sleeve 20 by passing the integrally vulcanized molded product 21 from a right end thereof through a left opening portion of the metal sleeve 20 to be pushed thereinto until the outer flange 16 is abutted with the left end surface of the metal sleeve 20. This results in the foregoing state where the metal sleeve 20 has been externally disposed on the outer cylindrical member 12, thereby forming the suspension bush 10 having the structure shown in FIG. 1.

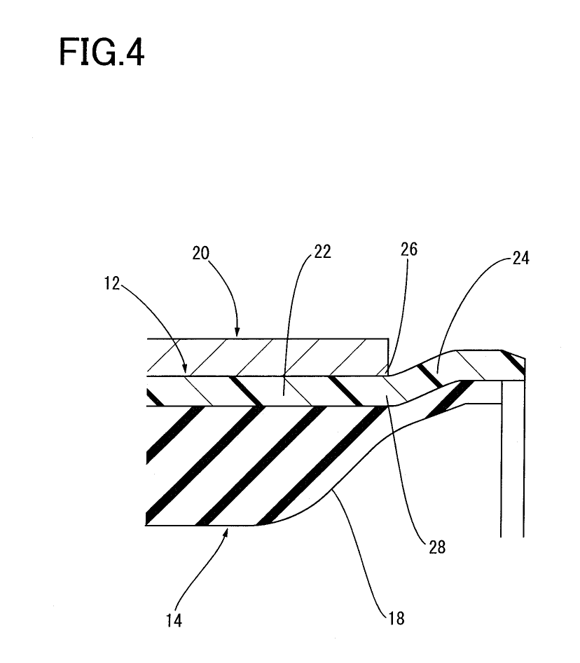

In the suspension bush 10 constructed as above, as shown in FIGS. 1 and 4, the outer flange 16 of the outer cylindrical member 12 and a right end portion thereof on an opposite side from the outer flange 16 are protruded outward in the axial direction from opposite-side openings of the metal sleeve 20, whereas an axial middle portion of the outer cylindrical member 12 between the outer flange 16 and the right end portion is positioned inside the metal sleeve 20 (internally disposed on the metal sleeve 20). In addition, the metal sleeve 20 has a thickness smaller by a predetermined size than a height (length) of the outer flange 16 protruding in the radially outward direction, whereby a tip portion of the outer flange 16 protruding outward in the axial direction from the left opening portion of the metal sleeve 20 is positioned so as to be protruded by a predetermined length in the radially outward direction from the outer circumferential surface of the metal sleeve 20. Moreover, since the outer diameter of the metal sleeve 20 is made larger by a predetermined size than the outer diameter of the outer cylindrical member 12, the outer circumferential surface of the outer cylindrical member 12 is positioned radially inward of an extended line of the outer circumferential surface of the metal sleeve 20 in the state where the metal sleeve 20 is externally fitted onto the outer cylindrical member 12.

In this manner, in the state where the metal sleeve 20 is externally fitted onto the outer cylindrical member 12, in other words, in the state where the outer cylindrical member 12 (the integrally vulcanized molded product 21) is press-fitted into the metal sleeve 20, the axial middle portion of the outer cylindrical member 12 located inside the metal sleeve 20 is referred to as a reduced diameter portion 22 where the diameter of the middle portion has been reduced by the metal sleeve 20 due to resin elasticity. Additionally, at the right end portion of the outer cylindrical member 12 protruding outward in the axial direction from the opening portion of the metal sleeve 20 at an axial end thereof, a portion except for the tip portion, which is axially adjacent to the reduced diameter portion 22, is referred to as an enlarged diameter portion 24 having a tapered tubular shape with a diameter gradually increasing in the axially outward direction (toward the right side) due to resilience of the resin of the outer cylindrical member 12. Furthermore, a bent portion positioned at a boundary of the reduced diameter portion 22 and the enlarged diameter portion 24 of the outer cylindrical member 12 is contacted and engaged with an inner corner portion 26 circumferentially disposed at the right end portion opposite to the side where the metal sleeve 20 is abutted with the outer flange 16, namely, the bent portion is referred to as an engagement bent portion 28 which connects and contacts the inner corner portion 26 formed by the right end surface and the inner circumferential surface of the metal sleeve 20.

In this manner, in the suspension bush 10 of the present embodiment, the entire outer circumferential surface of the reduced diameter portion 22 of the outer cylindrical member 12 is pressed against the entire inner circumferential surface of the metal sleeve 20, whereby the reduced diameter portion 22 of the outer cylindrical member 12 is retained by the metal sleeve 20, thereby allowing the outer cylindrical member 12 to be fixed to the metal sleeve 20. In the state where the outer cylindrical member 12 is fixed to the metal sleeve 20, the engagement bent portion 28 of the outer cylindrical member 12 is engaged with the inner corner portion 26 of the metal sleeve 20 to prevent entry of the enlarged diameter portion 24 into the metal sleeve 20, thereby restricting a displacement of the outer cylindrical member 12 to the left in an axial direction thereof (a direction from the enlarged diameter portion 24 to the reduced diameter portion 22) with respect to the metal sleeve 20. Additionally, since the outer flange 16 of the outer cylindrical member 12 is positioned so as to be contacted with the left end surface of the metal sleeve 20, the displacement of the outer cylindrical member 12 to the right in an axial direction thereof with respect to the metal sleeve 20 can also be restricted. As a result, it is prevented that the outer cylindrical member 12 is detached from the inside of the metal sleeve 20 in the axially opposite directions thereof. Accordingly, as apparent from this, in the present embodiment, the inner corner portion 26 of the metal sleeve 20 is formed as an engagement corner portion, and the metal sleeve 20 as a whole is formed as a retaining portion.

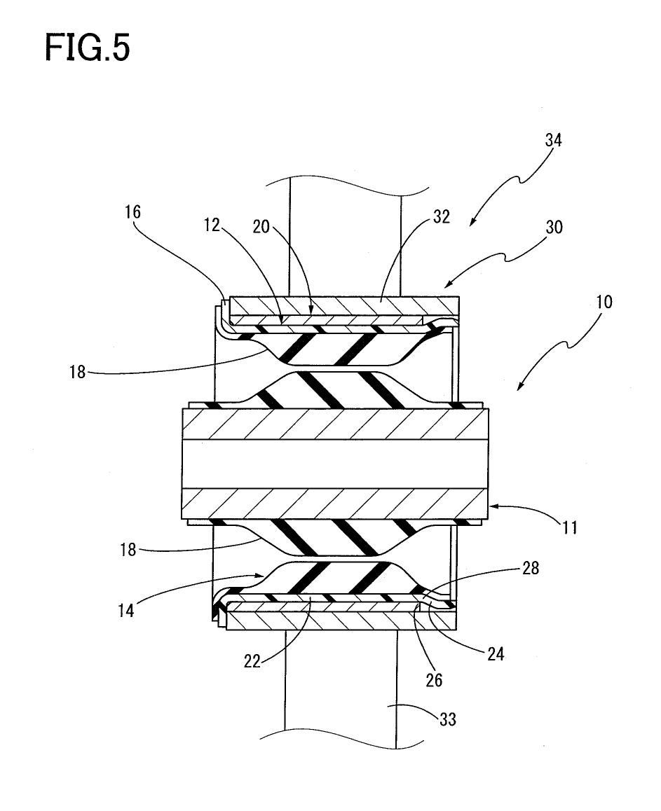

When the suspension bush 10 constructed as above is interposed between the trailing arm and the vehicle body frame, as shown in FIG. 5, the metal sleeve 20 is inserted into and fixed to a mounting tubular portion 32 of a mounting member 30 which is to be mounted on the body frame, in other words, the mounting tubular portion 32 of the mounting member 30 is externally fitted on and fixed to the metal sleeve 20. Consequently, a suspension bush assembly 34 that includes the suspension bush and the mounting member 30 is constructed. In FIG. 5, a reference numeral 33 denotes an arm extended out integrally from the mounting tubular portion 32.

More specifically, the mounting tubular portion 32 of the mounting portion 30 has a cylindrical shape as a whole and an inner circumferential surface thereof is a smooth surface corresponding with the outer circumferential surface of the metal sleeve 20. Additionally, the mounting tubular portion 32 has a thickness sufficiently larger than that of the metal sleeve 20, so that the mounting tubular portion 32 has rigidity much higher than that of the metal sleeve 20.

An axial length (height) of the mounting tubular portion 32 is larger than that of the metal sleeve 20 and also is substantially equal to a length obtained by subtracting the thickness of the outer flange 16 from an axial length of the outer cylindrical member 12 or slightly larger than that. Additionally, an inner diameter of the mounting tubular portion 32 is made slightly smaller by a predetermined size than the outer diameter of the metal sleeve 20.

The metal sleeve 20 having the large diameter is press-fitted into an inner hole of the mounting tubular portion 32 from a right end portion of the metal sleeve 20 through a left opening portion thereof and pushed thereinto until the outer flange 16 is abutted with a left end surface of the mounting tubular portion 32.

The entire outer circumferential surface of the metal sleeve 20 is pressed against the entire inner circumferential surface of the mounting tubular portion 32, whereby the metal sleeve 20 is retained by the mounting tubular portion 32 having the rigidity higher than that of the metal sleeve 20. The left end surface of the mounting tubular portion 32 is abutted with the outer flange 16 of the outer cylindrical member 12 press-fitted and fixed into the metal sleeve 20, thereby preventing the outer cylindrical member 20 from being detached from the mounting tubular portion 32 to the right in the axial direction thereof. Furthermore, the right end portion of the outer cylindrical member 12 protruding outward in the axial direction from the metal sleeve 20 is not protruded outward in the axial direction from the mounting tubular portion 32 but positioned radially inwardly of the mounting tubular portion 32. Thereby, in a state where the suspension bush 10 or the suspension bush assembly 34 is mounted on the vehicle, the right end portion of the mounting tubular portion 32 serves as a protecting portion for protecting the right end portion of the outer cylindrical member 12 protruded outward in the axial direction from the metal sleeve 20. As a result, it can be effectively prevented that the right end portion of the outer cylindrical member 12 comes into contact with another member and interfere with it or to be broken by it.

The mounting member 30 is fixed to the suspension bush 10 by the mounting tubular portion 32, and consequently the foregoing suspension bush assembly 34 is constructed. Next, the suspension bush assembly 34, and ultimately the suspension bush 10 is interposed between the vehicle body frame and the trailing arm, for example, by fastening and fixing a mounting bolt inserted through the inner cylindrical member 11 to the trailing arm, and so forth, while fixing the arm 33 of the mounting member 30 of the suspension bush assembly 34 to the vehicle body frame or the like.

In this case, the mounting member 30 used in the embodiment has the mounting tubular portion 32 with a thin thickness. Specifically, for example, the thickness of the mounting tubular portion 32 of the used mounting member 30 is thinner than that of the mounting tubular portion of the conventional suspension bush by a thickness of the metal sleeve 20. The conventional suspension bush includes only an inner cylindrical member, an outer cylindrical resin member, and an elastic body connecting the inner and outer cylindrical members to each other and does not include a metal sleeve externally fitted on the outer cylindrical member, so that the outer cylindrical member is directly press-fitted into the mounting tubular portion. Thereby, the entire weight of the suspension bush assembly 34 is made substantially equal to that of the conventional suspension bush assembly in which the metal sleeve is not externally fitted onto the outer cylindrical member. That is, unlike the conventional suspension bush assembly, in the suspension bush assembly 34 of the present embodiment, despite the addition of the metal sleeve 20, there is effectively ensured the advantage of weight reduction obtained by employing the outer cylindrical member 12 that is made of resin. Furthermore, as described above, since the outer circumferential surface of the outer cylindrical member 12 is positioned radially inwardly of the outer circumferential surface of the metal sleeve 20, the outer cylindrical member 12 pressed into the metal sleeve 20 does not hinder the metal sleeve 20 from being pressed into the mounting tubular portion 32.

As described above, in the present embodiment, the engagement bent portion 28 of the outer cylindrical member 12 is engaged with the inner corner portion 26 of the metal sleeve 20 externally fitted onto and fixed to the outer cylindrical member 12, and furthermore, the outer flange 16 of the outer cylindrical member 12 is engaged with the left end surface of the metal sleeve 20, thereby preventing the outer cylindrical member 12 from being detached from the inside of the metal sleeve 20 in the axially opposite sides thereof. In addition, in the state where the metal sleeve 20 is externally fitted onto and fixed to the outer cylindrical member 12, (in the state where the outer cylindrical member 12 is pressed and fixed into the metal sleeve 20), the metal sleeve 20 has the outer circumferential surface corresponding with the inner circumferential surface of the mounting tubular portion 32 of the mounting portion 30 and is pressed and fixed into the mounting tubular portion 32. In this manner, based on frictional resistance force generated by abutting the outer circumferential surface of the metal sleeve 20 against the inner circumferential surface of the mounting tubular portion 32, it is prevented that the metal sleeve 20 is detached from the inside of the mounting tubular portion 32 in the axially opposite sides thereof.

Therefore, the present embodiment can sufficiently ensure both detachment-resistant force of the outer cylindrical member 12 against the metal sleeve 20 and detachment-resistant force of the metal sleeve 20 against the mounting tubular portion 32, without disposing any special portion such as an engagement portion on the inner circumferential surface of the mounting tubular portion 32 of the mounting member 30 to prevent detachments of the outer cylindrical member 12 and the metal sleeve 20 from the mounting tubular portion 32.

Accordingly, the suspension bush 10 of the above embodiment requires no special process with extra cost or work on the mounting tubular portion 32 of the mounting member 30. The suspension bush 10 can be interposed between the vehicle body frame and the trailing arm in the state where the detachment of the outer cylindrical resin member 12 from the inside of the mounting tubular portion 32 can surely and stably be prevented over a long period of time. As a result, the suspension bush 10 can stably exhibit excellent vibration damping performance over a longer period of time, without requiring any troublesome and costly work.

Additionally, in the present embodiment, the inner and outer circumferential surfaces of the metal sleeve 20 are formed as the smooth surfaces, and there is formed no special portion such as a protrusion, a recess, or a stepped portion on the metal sleeve 20 to engage with the engagement bent portion 28 of the outer cylindrical member 12. The inner corner portion 26 formed between the end surface and the inner circumferential surface at a first axial end of the metal sleeve 20 is used as an engagement portion for engaging with the engagement bent portion 28 of the outer cylindrical member 12. Therefore, despite the addition of the metal sleeve 20 used as the constituent component for forming the suspension bush 10, it is possible to maximally prevent the complication of a production process of the constituent components included in the suspension bush 10, and ultimately, the complication of a process from the formation of the suspension bush 10 to mounting thereof onto the vehicle body or the like. As compared with the conventional suspension bush 10 requiring the formation of a special recess or stepped portion on the mounting tubular portion 32 of the mounting member 30, the embodiment of the present invention can advantageously simplify the process from the formation of the suspension bush 10 to the mounting thereof onto a vehicle body or the like.

While the preferred embodiment of the present invention has been described in detail, for illustrative purpose only, it is to be understood that the present invention is not limited to the details of the illustrated embodiment.

For example, in the present embodiment, the outer flange 16 is provided at a first axial end of the outer cylindrical member 12 (the left end in FIG. 1), whereas the engagement bent portion 28 is formed at a second axial end thereof (the right end in FIG. 1) by press-fitting the outer cylindrical member 12 into the metal sleeve 20, whereby the outer flange 16 is engaged with the end surface of the first axial end of the metal sleeve 20 and the engagement bent portion 28 is engaged with the inner corner portion 26 of the metal sleeve 20. The above structure can restrict or prevent the displacement (detachment) of the outer cylindrical member 12 toward the axially opposite sides thereof with respect to the metal sleeve 20. However, for example, as an alternative to the outer flange 16, the engagement bent portion 28 can be formed at the first axial end of the outer cylindrical member 12.

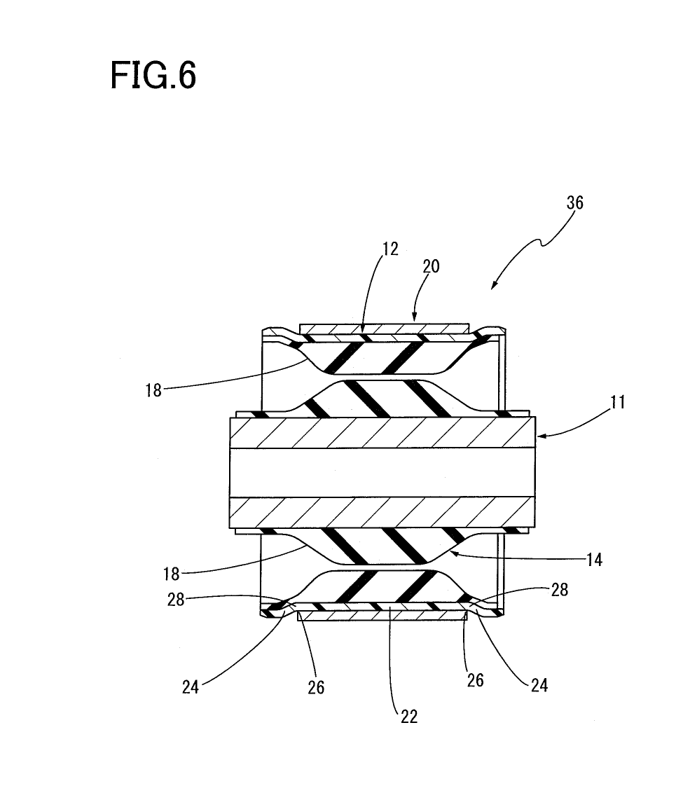

Specifically, in that case, as shown in FIG. 6, the outer cylindrical member 12 is pressed into the metal sleeve 20 and the axial middle portion thereof is fixed into the metal sleeve 20 having the inner diameter smaller than the outer diameter of the outer cylindrical member 12, so that the axial middle portion of the outer cylindrical member 12 is referred to as the reduced diameter portion 22. Meanwhile, the enlarged diameter portions 24, 24 are formed at each end portion on the axially opposite sides of the outer cylindrical member 12 protruding outward in the axial direction from each opening portion on the opposite sides of the metal sleeve 20. Additionally, the boundary portions between each of the two enlarged diameter portions 24, 24 and the reduced diameter portion 22 positioned therebetween is referred to as the engagement bent portions 28, 28. Each of the two engagement bent portions 28, 28 is engaged with each of the inner corner portions 26, 26 formed between the end surfaces of the axially opposite sides and the inner circumferential surfaces of the metal sleeve 20. As a result, the displacement (detachment) of the outer cylindrical member 12 toward the axially opposite sides thereof with respect to the metal sleeve 20 can be restricted or prevented.

The above structure can also advantageously provide the same excellent functions and effects as those in the foregoing embodiment. In addition to that, since the step of forming the outer flange 16 on the outer cylindrical member 12 can be omitted, reduction in cost and improved productivity of the outer cylindrical member 12, and consequently of the suspension bush 10 can advantageously be obtained.

In the present embodiment, the engagement corner portion is formed by the inner corner portion 26 at the axial end portion of the metal sleeve 20. Alternatively, for example, on the inner circumferential surface of the metal sleeve 20, there may be provided a stepped portion where the first axial end thereof has a thickness smaller than that of a second axial end thereof or has an inner diameter larger than that of the second axial end, or there may be provided a ridge extending continuously or intermittently in the circumferential direction, whereby the engagement corner portion can be formed by a corner portion of the stepped portion or the ridge. In this case, the enlarged diameter portion 24 is also positioned inside the metal sleeve 20.

The shape of the outer circumferential surface of the metal sleeve 20 is not limited to the exemplified smooth surface at all, and is formed to correspond with the shape of the inner circumferential surface of the mounting tubular portion 32 of the mounting member 30. Thus, for example, when there is formed a recess, a protrusion, a stepped portion, or the like on the inner circumferential surface of the mounting tubular portion 32, there is formed a protrusion, a recess, a stepped portion, or the like on the outer circumferential surface of the metal sleeve 20 corresponding to the inner circumferential surface of the mounting tubular portion 32.

The entire shape of the mounting tubular portion 32 is also not specifically limited. For example, the two mounting tubular portions 32, 32 each having an axial length shorter than that of the metal sleeve 20 may be externally fitted onto the metal sleeve 20 from the axially opposite sides of the metal sleeve 20.

The inner cylindrical member 11 as the inner shaft member and the mounting member 30 are not particularly limited to metallic products as long as they have sufficient rigidity.

The inner shaft member is not limited to the inner cylindrical member 11, and may be a solid member such as a bolt member.

In the present embodiment, the entire metal sleeve 20 forms the retaining portion. Alternatively, for example, at a part of the metal sleeve 20, there may be formed a portion having an inner diameter smaller than the outer diameter of the outer cylindrical member 12, and only the portion may be used as the retaining portion.

In the present embodiment, the outer cylindrical member 12 is press-fitted into the metal sleeve 20. The metal sleeve 20 may be externally fitted and fixed on the outer cylindrical member by reducing the diameter of the metal sleeve 20 by a diameter-reducing operation such as drawing in the state where the outer cylindrical member 12 is inserted into the metal sleeve 20. In this case, the outer cylindrical member 12 positioned inside the metal sleeve 20 is referred to as the reduced diameter portion 22 having the diameter reduced based on the resin elasticity, whereas the portion of the outer cylindrical member 12 that is protruded outward in the axial direction from the opening portion of the metal sleeve 20 and that is axially adjacent to the reduced diameter portion 22 is referred to as the enlarged diameter portion 24 with the diameter gradually increasing toward the side opposite to the reduced diameter portion 22, without any diameter reduction force applied by the metal sleeve 20. Additionally, the boundary portion between the reduced diameter portion 22 and the enlarged diameter portion 24 is referred to as the engagement bent portion 28.

While the concrete examples of the present invention has been described in the above embodiment in which the present invention is applied to the suspension bush and the suspension bush assembly to be interposed between the body frame and the trailing arm of an automobile, the principle of the present invention is advantageously applicable to any other suspension bush and any other suspension bush assembly for other members of automobiles, any vibration damping bush and any vibration damping bush assembly other than them, and furthermore, any vibration damping bush and any vibration damping assembly for vehicles other than automobiles, and so forth.

It is to be understood that the present invention may be embodied with various other changes and modifications which may occur to those skilled in the art, without departing from the spirit and scope of the invention defined in the attached claims.

What is claimed is:

1. A vibration damping bush comprising:
an inner shaft member;
an outer cylindrical resin member disposed radially outwardly of the inner shaft member with a predetermined distance therebetween and to be fixed in a tubular portion of a rigid mounting member;
an elastic body interposed between and elastically connecting the inner shaft member and the outer cylindrical resin member; and
a metal sleeve externally fitted onto the outer cylindrical resin member and to be fixed in the tubular portion of the mounting member,
wherein the metal sleeve includes a retaining portion having an inner diameter smaller than an outer diameter of the outer cylindrical resin member, and an engagement corner portion circumferentially positioned on an inner circumferential surface side of an axial edge region of the retaining portion of the metal sleeve;
the outer cylindrical resin member includes a reduced diameter portion positioned inside of and reduced by the retaining portion of the metal sleeve and an enlarged diameter portion positioned axially adjacent to the reduced diameter portion with a diameter gradually enlarged toward a side opposite to the reduced diameter portion in a state where the metal sleeve is externally fitted onto the outer cylindrical resin member, whereby the outer cylindrical resin member is retained by the retaining portion of the metal sleeve at the reduced diameter portion thereof; and
a boundary portion between the reduced diameter portion and the enlarged diameter portion of the outer cylindrical resin member is engaged with the engagement corner portion of the metal sleeve, thereby restricting an axial displacement of the outer cylindrical resin member from the enlarged diameter portion to the reduced diameter portion with respect to the metal sleeve.

2. The vibration damping bush according to claim 1, wherein an axial middle portion of the outer cylindrical resin member is formed as the reduced diameter portion, whereas a first axial end portion of the outer cylindrical resin member is formed as the enlarged diameter portion, and
wherein the vibration damping bush further comprises an outer flange integrally and circumferentially disposed on a second axial end portion of the outer cylindrical resin member, the outer flange being engaged with an end surface opposite to the engagement corner portion of the retaining portion of the metal sleeve in the state where the metal sleeve is externally fitted onto the outer cylindrical resin member, thereby restricting an axial displacement of the outer cylindrical resin member from the reduced diameter portion to the enlarged diameter portion with respect to the metal sleeve.

3. The vibration damping bush according to claim 1, wherein an axial middle portion of the outer cylindrical resin member is formed as the reduced diameter portion, whereas each of axially opposite end portions of the outer cylindrical resin member is formed as the enlarged diameter portion, and
wherein boundary portions between each of the enlarged diameter portions and the reduced diameter portion positioned between the enlarged diameter portions is engaged with each of the engagement corner portions circumferentially positioned on the inner circumferential surface side of each of the axial edge regions on axially opposite sides of the retaining portion of the metal sleeve, thereby restricting a displacement of the outer cylindrical resin member toward the axially opposite sides with respect to the metal sleeve.

4. A vibration damping bush assembly including a vibration damping bush and a rigid mounting member,
the vibration damping bush comprising;
an inner shaft member;
an outer cylindrical resin member disposed radially outwardly of the inner shaft member with a predetermined distance therebetween and to be fixed in a tubular portion of the rigid mounting member; and
an elastic body interposed between and elastically connecting the inner shaft member and the outer cylindrical resin member,
wherein the vibration damping bush further comprise a metal sleeve externally fitted onto the outer cylindrical resin member, the metal sleeve including a retaining portion having an inner diameter smaller than an outer diameter of the outer cylindrical resin member, and an engagement corner portion circumferentially positioned on an inner circumferential surface side of an axial edge region of the retaining portion in the metal sleeve;
wherein the outer cylindrical resin member includes a reduced diameter portion positioned inside of and reduced by the retaining portion of the metal sleeve and an enlarged diameter portion positioned axially adjacent to the reduced diameter portion with a diameter gradually enlarged toward a side opposite to the reduced diameter portion in a state where the metal sleeve is externally fitted onto the outer cylindrical resin member, whereby the outer cylindrical resin member is retained by the retaining portion of the metal sleeve at the reduced diameter portion thereof; and
wherein a boundary portion between the reduced diameter portion and the enlarged diameter portion of the outer cylindrical resin member is engaged with the engagement corner portion of the metal sleeve, thereby restricting an axial displacement of the outer cylindrical resin member from the enlarged diameter portion to the reduced diameter portion with respect to the metal sleeve,
the metal sleeve of the vibration damping bush being press-fitted into a tubular portion of the rigid mounting member, whereby the outer cylindrical resin member is inserted and fixed into the tubular portion of the mounting member to construct the vibration damping bush assembly.

5. A vibration damping bush assembly including a vibration damping bush and a rigid mounting member according to claim 4, wherein an axial middle portion of the outer cylindrical resin member is formed as the reduced diameter portion, whereas a first axial end portion of the outer cylindrical resin member is formed as the enlarged diameter portion, and
wherein the vibration damping bush further comprises an outer flange integrally and circumferentially disposed on a second axial end portion of the outer cylindrical resin member, the outer flange being engaged with an end surface opposite to the engagement corner portion of the retaining portion of the metal sleeve in the state where the metal sleeve is externally fitted onto the outer cylindrical resin member, thereby restricting an axial displacement of the outer cylindrical resin member from the reduced diameter portion to the enlarged diameter portion with respect to the metal sleeve.

6. A vibration damping bush assembly including a vibration damping bush and a rigid mounting member according to claim 4, wherein an axial middle portion of the outer cylindrical resin member is formed as the reduced diameter portion, whereas each of axially opposite end portions of the outer cylindrical resin member is formed as the enlarged diameter portion, and
wherein boundary portions between each of the enlarged diameter portions and the reduced diameter portion positioned between the enlarged diameter portions is engaged with each of the engagement corner portions circumferentially positioned on the inner circumferential surface side of each of the axial edge regions on axially opposite sides of the retaining portion of the metal sleeve, thereby restricting a displacement of the outer cylindrical resin member toward the axially opposite sides with respect to the metal sleeve.
